(19) United States
(12) Patent Application Publication
(10) Pub. No.: US 2015/0067283 A1
(43) Pub. Date: Mar. 5, 2015

(54) Image Deduplication of Guest Virtual Machines

(71) Applicant: International Business Machines Corporation, Armonk, NY (US)

(72) Inventors: Gaurab Basu, West Bengal (IN); Shripad Nadgowda, Nagpur (IN); Akshat Verma, New Delhi (IN)

(73) Assignee: International Business Machines Corporation, Armonk, NY (US)

(21) Appl. No.: 14/010,865

(22) Filed: Aug. 27, 2013

(51) Int. Cl. G06F 3/06

(52) U.S. Cl. CPC G06F 3/061; G06F 3/0641; G06F 3/0674
USPC 711/162

(57) ABSTRACT

Methods, systems, and articles of manufacture for image deduplication of guest virtual machines are provided herein. A method includes implementing a shared image file on a host server, transparently consolidating multiple duplicate blocks across multiple virtual machines on the shared image file, and creating a merged data path for the multiple virtual machines via the shared image file based on the multiple consolidated duplicate blocks.

### FIELD OF THE INVENTION

Embodiments of the invention generally relate to information technology, and, more particularly, to virtualization technology.

### BACKGROUND

In existing storage approaches for virtual machines (VMs), each VM includes an abstraction of a disk in the form of the VM's private disk image, and each disk image is a single flat file. Disk images for all guest VMs are stored in isolation, but typically on the same storage provisioned by the host server. Additionally, data paths for different guest VMs merge at the host storage.

Application input/outputs (I/Os) for each VM are served from their respective disk images. For each data write, space is first allocated on the disk image of the respective VM, and the address of the data is determined from the position of this pre-allocated space in the disk image. Also, at the host, each I/O caches data in the memory so that subsequent data requests can be served from the cache.

Accordingly, while virtualization allows multiple virtual machines to be consolidated onto a shared physical server, an overhead on I/O performance of workloads is imposed.

### SUMMARY

In one aspect of the present invention, techniques for image deduplication of guest virtual machines are provided. An exemplary computer-implemented method can include steps of implementing a shared image file on a host server, transparently consolidating multiple duplicate blocks across multiple virtual machines on the shared image file, and creating a merged data path for the multiple virtual machines via the shared image file based on the multiple consolidated duplicate blocks.

In another aspect of the invention, an exemplary computer-implemented method can include steps of pre-allocating storage space on a shared image file on a host server, wherein said pre-allocating comprises pre-allocating one unit of storage space per each one of multiple virtual machines; consolidating multiple duplicate blocks across the multiple virtual machines on the pre-allocated storage space on the shared image file; and creating a merged data path for the multiple virtual machines via the shared image file based on the multiple consolidated duplicate blocks.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof;

the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating example system components, according to an embodiment of the present invention;

FIG. 2 is a diagram illustrating dynamic space allocation, according to an embodiment of the present invention;

FIG. 3 is a diagram illustrating example components implemented in a distributed index look-up, according to an embodiment of the present invention;

FIG. 4 is a diagram illustrating an example distributed hash map implementation, according to an embodiment of the present invention;

FIG. 5 is a flow diagram illustrating techniques according to an embodiment of the invention; and

FIG. 6 is a system diagram of an exemplary computer system on which at least one embodiment of the invention can be implemented.

### DETAILED DESCRIPTION

As described herein, an aspect of the present invention includes techniques for image deduplication of guest virtual machines (VMs). At least one embodiment of the invention includes consolidating data paths to improve I/O performance. For example, at least one embodiment of the invention includes the design and implementation of a lean virtual disk (LVD), a virtual disk format for virtualized servers. As detailed herein, an LVD transparently consolidates duplicate blocks across virtual machines to create a lean disk image, leading to a merged data path for all relevant virtual machines. This merged data path facilitates efficient storage usage, reduction in disk 110 (read/write) redundancy for the same data across VMs and efficient host cache utilization without depending on shared page merging.

Additionally, an LVD is motivated by clouds, wherein VMs are created from golden masters and use standardized middleware and management tools. For example, an LVD can be implemented within the context of common content across virtual machines being stored multiple times within each disk file. Further, many system management activities and applications read this content and cache the content in page caches without leveraging content already present in other virtual machines. Accordingly, at least one embodiment of the invention includes using a shared image file, which is a merged collection of disk blocks across virtual machines. Merging data across multiple virtual machines to common physical sector addresses allows an LVD to trivially leverage existing host page caches, leading to significant performance improvements.

As such, an example embodiment of the invention includes creating a common shared image file on a host server to contain all blocks across all VMs, and allowing multiple guest VMs to transparently share the common disk image. Also, for each VM, such an example embodiment can further include redirecting I/O from the VM's private disk image to the common shared disk image. Further, a distributed deduplication can be added across VMs using the common shared disk image, and an optimized data path merge point can be created for the VMs.

By way merely of illustration and not limitation, an example embodiment of the invention will be described within the context of an implemented LVD as an extension to the qcow2 image format. It should be appreciated by one skilled in the art that qcow2 is merely an example implementation context, and that additional image formats and/or contexts can be utilized in connection with one or more embodiments of the invention. Additionally, qcow2, for completeness, is an updated version of qcow (QEMU Copy On Write), and is also open source and a widely used disk image format.

Accordingly, in such an example embodiment, qcow2 stores data in the units of clusters, which can be considered as the fundamental unit of data I/O on the image file. A typical size of the cluster can be configured between 4 kilobytes (KB) and 64 KB.

Each cluster includes multiple sections, which are 512 bytes each. Logical address translation is performed using 2-level address lookup that includes L1 tables and L2 tables. Entries in L1 tables map to L2 tables with entries in L2 tables pointing to clusters. Each entry in the L1 and L2 tables is 8 bytes, and L1 tables are fixed and allocated at the start of the image file while L2 tables and data clusters are allocated dynamically, allowing L2 and data to be located close to each other. L1 tables are typically cached in main memory for performance.

Additionally, a virtual address is 64 bits long and includes three parts. The least significant bits (LSB) map to a location within the cluster and are determined by the configured size of the cluster (for example, for 4 KB clusters, 12 LSB bits will be cluster-bits). The next set of bits includes a set of L2-bits which are used as an index to an L2 table. Because hash values associated with each L2 entry are being stored, the L2 table is a single cluster containing 32 byte entries. Accordingly, L2-bits=cluster-bits−5. Remaining bits are identified as L1-bits, which index into an L1 table.

Qcow2 allows VMs to start with a read-only shared “base image” or “backing file,” and each VM's own clean private image file. As used herein, “base image” and “private image” are used interchangeably, and refer to the disk image file owned by the VM where the file will store its data. Additionally, a “backing file,” as used herein, refers to the read-only image which stores the un-modified contents of the image file. The base image is marked as copy-on-write, allowing any write operations to the base image to be redirected to the private image file. Hence, the private image only contains the changed clusters with respect to its base image.

A snapshot is a variant of COW recording the point-in-time state of the image file. When a snapshot is created, metadata for every cluster (that is, every entry in the complete L2 table) is updated to turn on the copy-on-write bit. For any subsequent write, this bit is checked and a new cluster is allocated for storing the data. Accordingly, qcow2 natively supports a mechanism to trap writes to pre-specified clusters and write them to new locations. Further, qcow2 natively supports redirecting requests from one image file to another image file.

In order to support snapshots, qcow2 maintains a reference count for each cluster. The reference count is maintained in a reference table with a 2-byte reference count for each physical cluster. A cluster with a reference count greater than 1 indicates one or more active snapshots for an image.

As detailed herein, at least one embodiment of the invention includes enhancing qcow2 to support lean disks, which deduplicates clusters across multiple virtual machines. By way of example, at least one embodiment of the invention includes extending qcow2 to support specifying a shared image file for VMs. The traditional interface to create a VM, wherein the new file is the private file created for the VM and back file is the base image. A VM supporting an LVD supports an additional parameter referred to herein as a share file. Multiple VMs that share the share file can use merged data clusters on the share file.

Because all accesses are rooted at the private image file, the shared image file is stored in the header of the private image file. Any requests to blocks that are not present in the private image file are routed to the shared image file using redirection employed to support snapshots.

Qcow2 maps logical addresses to physical addresses using two-levels of indirections (for example, L1 and L2 tables, as noted above). For each VM, a logical address indicates how the VM sees the address space of the underlying storage, and logical addresses can overlap across virtual machines. This does not create an issue in qcow2 because requests from different VMs are mapped to different disk image files. With an LVD, at least one embodiment of the invention avoids cluster address collisions by masking cluster addresses for each VM. When a VM is created and/or launched with an LVD, a 4-bit unique identifier is assigned to that VM and is persisted in the header of the VM's private file. Each read/write request coming from the VM is then translated by masking 4 most significant bits (MSBs) of the logical address with the respective VM's identifier. This ensures that the shared file views different logical addresses for requests coming from different VMs, and can use appropriate L1 and L2 tables to resolve these addresses. The logical address in an LVD is thus split into four parts: VM-bits, L1-bits, L2-bits and cluster-bits. At least one example embodiment of the invention includes using 4 bits for a VM by default, allowing 16 VMs to share one shared file. Increasing by one additional bit can allow sharing on hosts with a higher VM density.

The structure of the shared file leverages concepts employed by qcow2 to ensure locality between metadata and data. At least one embodiment of the invention includes pre-allocating clusters to place L1 tables for up to 16 VMs at the start of the shared file. Clusters for L2 tables and data clusters are allocated dynamically. Hence, L1 tables are cached in memory whereas L2 tables and their corresponding data clusters are spatially close to each other. It should also be noted that at least one embodiment of the invention includes not sharing metadata (either L1 or L2 tables) across images. This allows metadata to be updated across different virtual machines completely independently.

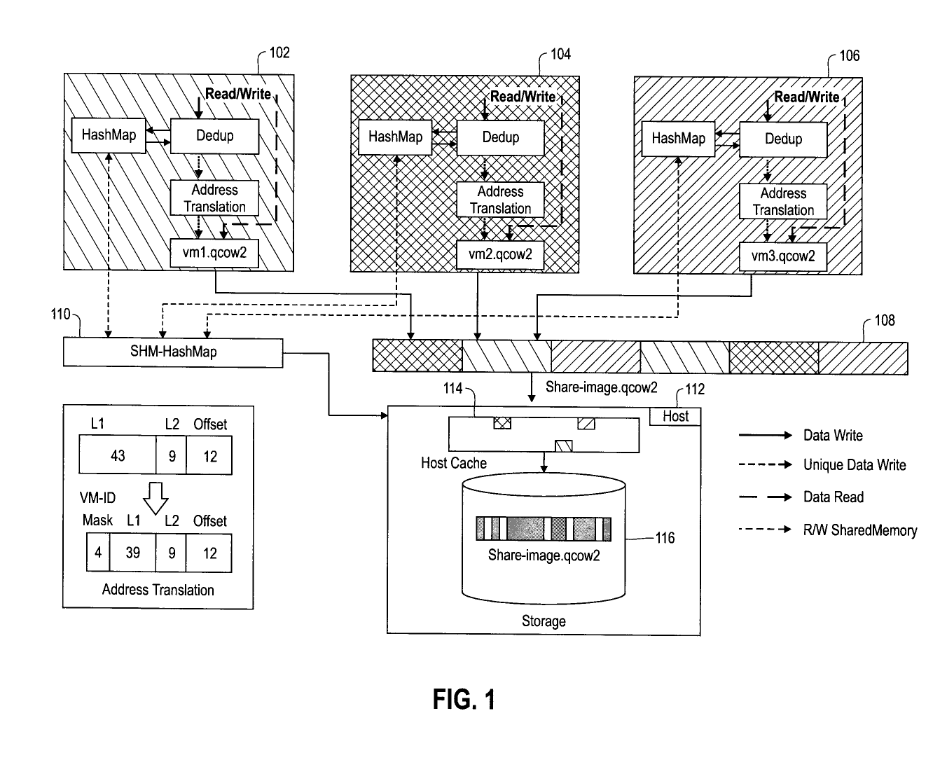

FIG. 1 is a diagram illustrating example system components, according to an embodiment of the present invention. By way of illustration, FIG. 1 depicts VM 102, VM 104 and VM 106, as well as a sparse hash map (SHM) 110 and shared image file 108. Additionally, FIG. 1 depicts a host 112, which includes a host cache 114 and a host database 116.

As detailed herein, an aspect of the invention includes allowing multiple guest VMs (for example, VMs 102, 104 and 106) on the same physical server (for example, host 112) to share a disk image file (for example, shared image file 108). Such an aspect of the invention includes, as described herein, address translation, wherein each write of a VM is masked by its own identifier (ID).

Additionally, as noted herein, at least one embodiment of the invention includes dynamic pre-allocation of space in a common file. By way of example, each VM is pre-allocated one unit (typically 1 gigabyte (GB), but that value can be configurable) storage at start-up. Each VM can write unique data to its pre-allocated space, and dynamic expansion can occur with more pre-allocated blocks as storage needs grow. Such techniques ensure data locality for each VM, avoid cluster contention on a common file by different VMs, and improve concurrency with simultaneous writes to a common file from different VMs.

Also, at least one embodiment of the invention includes distributed inline deduplication, which functions across multiple VMs simultaneously. For example, deduplication can be applied to inline and/or live data paths, and deduplication can be moved approximate to the I/O path.

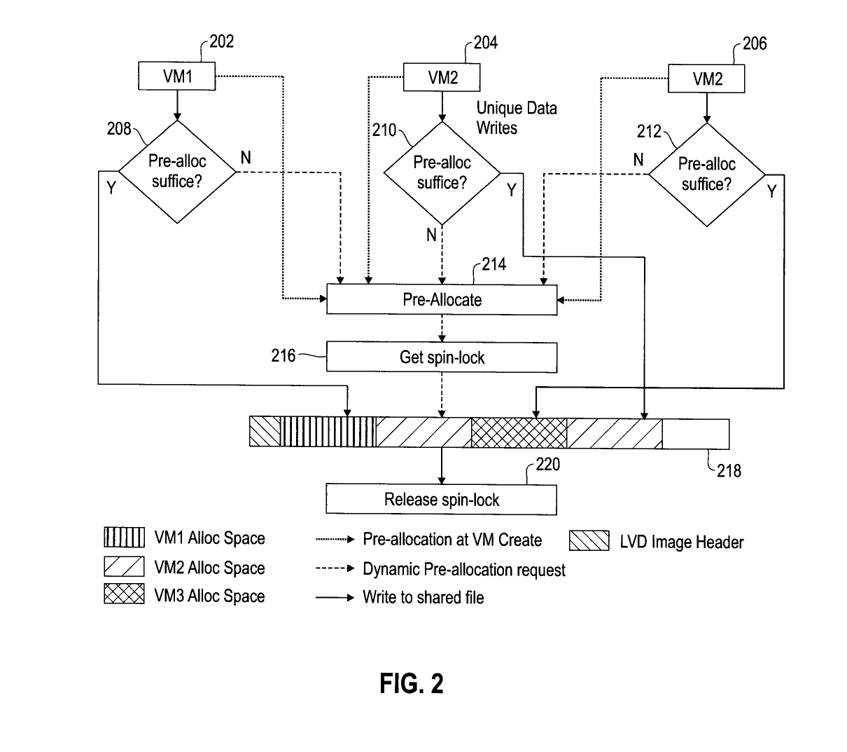

FIG. 2 is a diagram illustrating dynamic space allocation, according to an embodiment of the present invention. By way of illustration, FIG. 2 depicts VM 202, VM 204 and VM 206. FIG. 2 also depicts a number of steps, including steps 208, 210 and 212, which include determining whether pre-allocation associated with a given VM (that is, 202, 204 or 206, respectively) is sufficient. If a given pre-allocation is sufficient, data from the respective VM are allocated to a shared image file 218. If a given pre-allocation is not sufficient, the process for that respective VM continues to pre-allocation at step 214 and to obtaining a spin-lock at step 216, prior to allocating data to the shared image file 218 and releasing the spin-lock in step 220. As detailed herein, a “spin-lock” is used to achieve mutually exclusive access to a shared image file.

As noted herein, qcow2 is a sparse image format that does not pre-allocate any space for data clusters. When a write request needs space, a request is made to the driver to allocate a cluster for the list of free clusters. If no free clusters are available, a request is made to the raw disk driver for additional space to grow the file. The space allocation algorithms for the qcow2 driver as well as the raw driver work under the assumption that requests exhibiting temporal locality are related and are allocated space close to each other. Further, space allocation does not require locking, as multiple concurrent requests for space are not made.

Sharing one disk file across multiple VMs breaks the assumption that temporally correlated write requests are logically related. Hence, write requests from VMs may be allocated space which overlap with each other, leading to degraded I/O performance due to fragmentation. Accordingly, at least one embodiment of the invention includes changing the allocation policy to allocate coarse-grained space for each request. In such a coarse-grained provisioning model, at least one embodiment of the invention includes allocating a predefined number of clusters to the VM at the time of instantiation. When the allocated space runs out, additional amounts can be allocated from the next available location in the shared image file.

As illustrated in FIG. 2, dynamic space allocation across multiple virtual machines is implemented with the help of spin-locks. When space is being allocated for one virtual machine, all other space allocation requests wait for the lock. FIG. 2 captures the space allocation process implemented by an LVD. As such, coarse-grained dynamic allocation facilitates two goals simultaneously: (i) Clusters for one VM are almost contiguous; and (ii) Space allocation requests are infrequent, and hence, locking does not lead to performance issues.

It can also be noted that the space allocated for each VM is only semi-private. Duplicate blocks across VMs are permitted to be merged and shared across VMs. Hence, the L2 table of a VM is allowed to map to the private data space of a different VM. The semi-private space allocation facilitates the benefits of deduplication, while ensuring that the performance of unique data is not impacted.

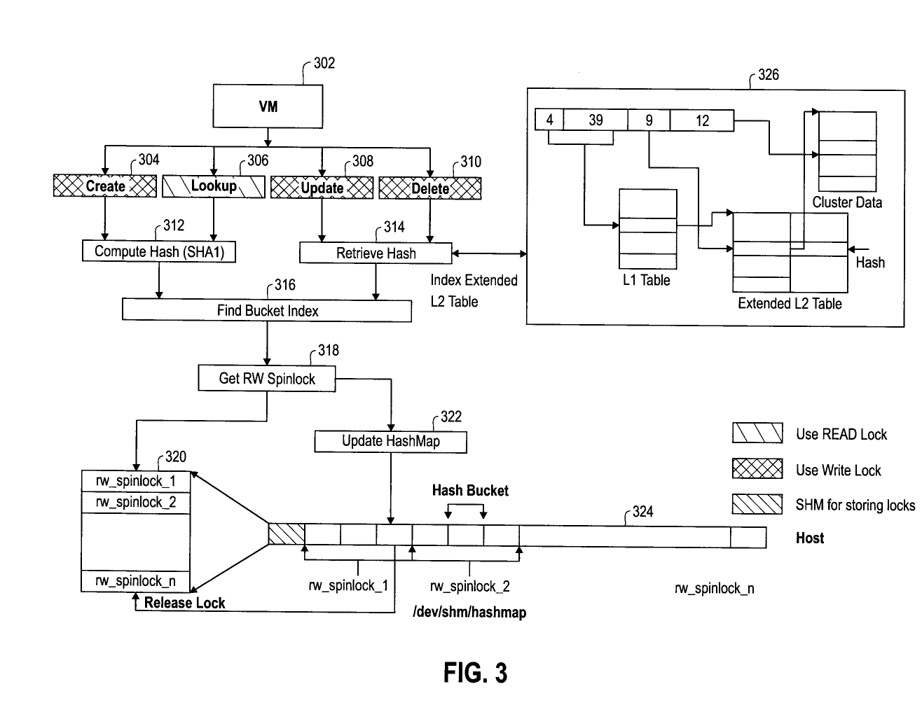

FIG. 3 is a diagram illustrating example components implemented in a distributed index look-up, according to an embodiment of the present invention. By way of illustration, FIG. 3 depicts a VM 302 as well as multiple operations. For example, step 304 includes a create operation, step 306 includes a lookup operation, step 308 includes an update operation and step 310 includes a delete operation. With a unique data write operation, a <Hash value, offset> entry will be updated in the hash map, and a <L2, Hash value> entry will be updated in extended L2 table 326. With a duplicate data write operation, a <L2, Hash value> entry will be updated in the extended L2 table 326. With a data deletion operation, a <Hash value> entry is indexed from the extended L2 table 326 and a <Hash value, offset> entry is removed from the hash map. With a data update operation, a data deletion operation is implemented for old data while a data write operation is implemented for new data.

Further, step 312 includes computing a hash value, while step 314 includes retrieving a hash value from an index extended L2 table 326. Step 316 includes identifying a bucket index, and a read/write spin-lock is obtained in step 318 prior to allocating data to the shared image file 320 and releasing the spin-lock. Additionally, step 322 includes updating the hash map prior to providing input to the host 324.

At least one embodiment of the invention includes hash map space management that includes implementing an eviction policy based on recency and popularity. Also, in an example embodiment of the invention, at the time of creation of a disk image, each VM is pre-allocated one block, and pre-allocation on a common disk image is synchronized across VMs. Further, each VM is dynamically pre-allocated one block at-a-time. Multiple VMs can write simultaneously (without a lock) at different blocks of common disk image, and concurrency is impacted only for space allocation.

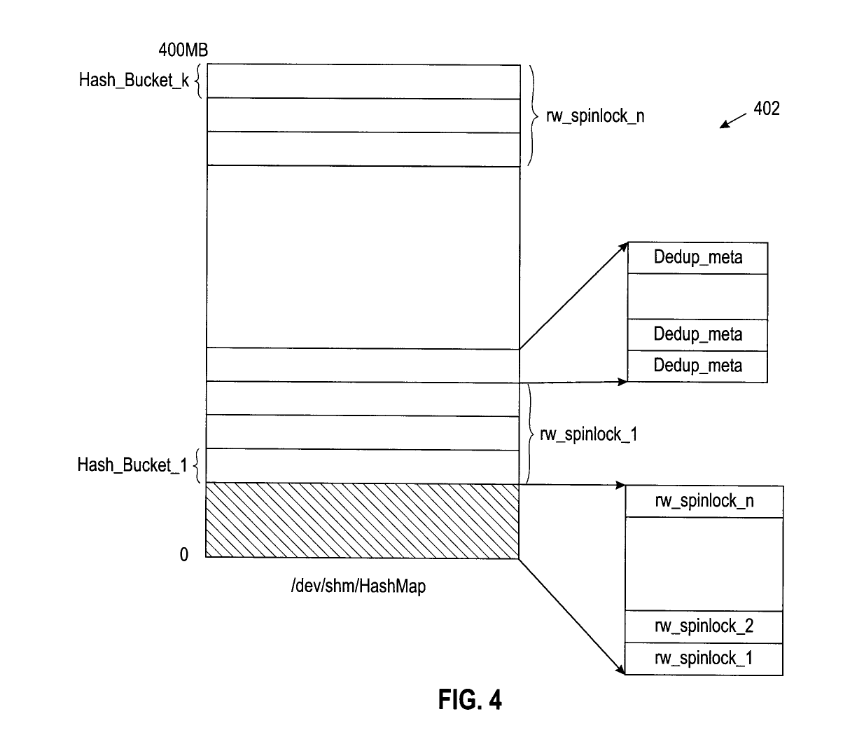

FIG. 4 is a diagram illustrating an example distributed hash map 402 implementation, according to an embodiment of the present invention. One operation in an LVD is to identify if content being written has an existing duplicate. This operation, in at least one embodiment of the invention, is performed in each VM. FIG. 4 depicts implementation of a distributed hash index to support this operation in a scalable fashion. The hash index is implemented as a hash map using shared memory as an inter-process communication (IPC) mechanism. The shared memory is created on the host at system startup and can be persisted. In at least one embodiment of the invention, the system is not persisted at shutdown.

The hash index maintains metadata for a set of recently written clusters. B y way merely of example, each entry in the index can be 40 bytes and include the SHA-1 hash value (32 bytes) and the physical address (8 bytes) for the content.

In typical deduplication systems, there is a single data path coming to the deduplication system to ensure consistency of the metadata updates. In at least one embodiment of the invention, the hash map can be updated in parallel by different VMs. Locking the entire hash map for each update can lead to contention between virtual machines. Accordingly, at least one embodiment of the invention includes defining a custom two-level hash lookup with range locks. For example, the complete hash map space from shared memory can be divided into fixed-size hash buckets. The total number of hash buckets can be configurable.

In this two-level hash lookup, given the hash value, at least one embodiment of the invention includes identifying the bucket index using the first 20 bits of the hash (by way merely of example). The content hash is then searched sequentially inside the bucket. For implementing consistency, at least one embodiment of the invention can include creating a pool of read-write spin-locks. Each spin-lock is used to maintain consistency for a collection of hash buckets. When a bucket index is computed, the same index is used to map into this pool of read-write spin-locks to acquire the corresponding read-write spin-lock.

As noted above, FIG. 4 captures the structure of the hash map 402 and a hash map (such as, for example, depicted in FIG. 2) can be updated accordingly. Additionally, at least one embodiment of the invention includes implementing a fixed-size hash map as well as fixed-size buckets, and can also include implementing an eviction policy for each bucket. Such an eviction policy can include a random eviction policy, wherein the entry to be evicted from the bucket is selected at random.

As noted herein, qcow2 also uses a reference count (RefCount) table to maintain snapshots. A RefCount is maintained in a table with a 2-byte reference count for every cluster on the image and is referred to as the RefCount Table. Every cluster write changes the RefCount and leads to an update on the RefCount table. Additionally, qcow2 can implement an optimization to avoid such updates, which reserves a single-bit in the L2 table for each cluster. When a snapshot is taken, this single-bit is set to 1 for all L2 entries (that is, cluster offsets) for that image. For subsequent writes, this single-bit is used to assess whether the cluster has a reference count greater than one. If the bit is not set, the RefCount table is not accessed.

At least one embodiment of the invention includes changing the semantics of copy-on-write (cow). For example, a cluster is marked for copy-on-write only when the cluster gets deduplicated and is being shared across multiple VMs (or even within a single VM). Also, due to deduplication, the clusters may be shared across VMs. Accordingly, at least one embodiment of the invention can include implementing a single globally synchronized RefCount table for a shared image file.

The RefCount table is made global by hosting the table in the shared memory so that the LVD driver for all VMs can access the table. Consistency of the table is maintained using range locks in the same manner that the hash index is implemented. At least one embodiment of the invention can also include optimizing the size of the table by using three bits per cluster instead of 16 bits (as in qcow2).

The distributed hash map in an LVD is a cached copy of all unique content stored at a given point in time. If unique content is deleted from the physical space, the hash map also should be updated to invalidate the content. In at least one embodiment of the invention, whenever a data cluster is deleted or its content modified, the reference count for the original cluster is decremented. Also, the entry can be removed from the hash map when the reference count reaches 0. Each write request provides the logical address and the new content. However, at least one embodiment of the invention additionally includes requiring the hash map entry with the old content for the cluster to be identified.

To perform the lookup, at least one embodiment of the invention includes extending the qcow2 L2 table in an LVD. The L2 table is used during address resolution for each data request and the L2 table has its own caching policy. In an LVD, additional bytes (for example, an additional 20 bytes) are used to store the SHA1 hash of the content in the cluster and 4 bytes of padding. This facilitates a lookup of the hash map whenever older content is rewritten. Also, at least one embodiment of the invention includes increasing the size of the L2 table cache (for example, increasing the cache from 16 L2 tables to 32 L2 tables, allowing 4096 L2 entries to be cached). Additionally, pre-fetching can be implemented to fetch four L2 clusters for every single L2 cache during pre-allocation.

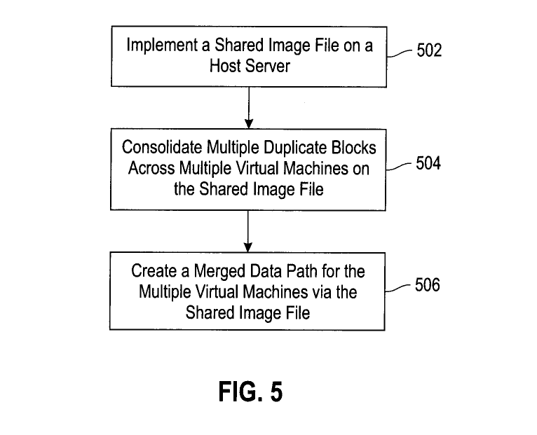

FIG. 5 is a flow diagram illustrating techniques according to an embodiment of the present invention. Step 502 includes implementing a shared image file on a host server. The shared image file includes a merged collection of multiple disk blocks across the multiple virtual machines. Additionally, the shared image file can be stored in a header of a private image file. Also, in at least one embodiment of the invention, the shared image file can include multiple fixed-size hash components, wherein the number of said multiple fixed-size hash components is configurable.

Step 504 includes consolidating multiple duplicate blocks across multiple virtual machines on the shared image file. Consolidating includes creating a lean disk image associated with the multiple virtual machines. Step 506 includes creating a merged data path for the multiple virtual machines via the shared image file based on the multiple consolidated duplicate blocks. At least one embodiment of the invention can also include leveraging one or more existing host page caches to improve performance.

The techniques depicted in FIG. 5 can also include facilitating multiple guest virtual machines to transparently share the shared image file, as well as redirecting input/output from a private disk image of each of the multiple virtual machines to the shared image file. Additionally, at least one embodiment of the invention includes incorporating a distributed deduplication across the multiple virtual machines using the shared image file. Further, in an example embodiment of the invention, each write operation performed by one of the multiple virtual machines is masked by an identifier corresponding to the one virtual machine.

Additionally, at least one embodiment of the invention includes pre-allocating storage space on a shared image file on a host server, wherein said pre-allocating includes pre-allocating one unit of storage space per each one of multiple virtual machines. Such an embodiment can also include consolidating multiple duplicate blocks across the multiple virtual machines on the pre-allocated storage space on the shared image file, and creating a merged data path for the multiple virtual machines via the shared image file based on the multiple consolidated duplicate blocks. Further, such an embodiment can include allocating an additional amount of storage space to one of the multiple virtual machines, such as, for example, allocating an additional amount of storage space from a nearest available location in the shared image file.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then to be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and configured to perform exemplary method steps.

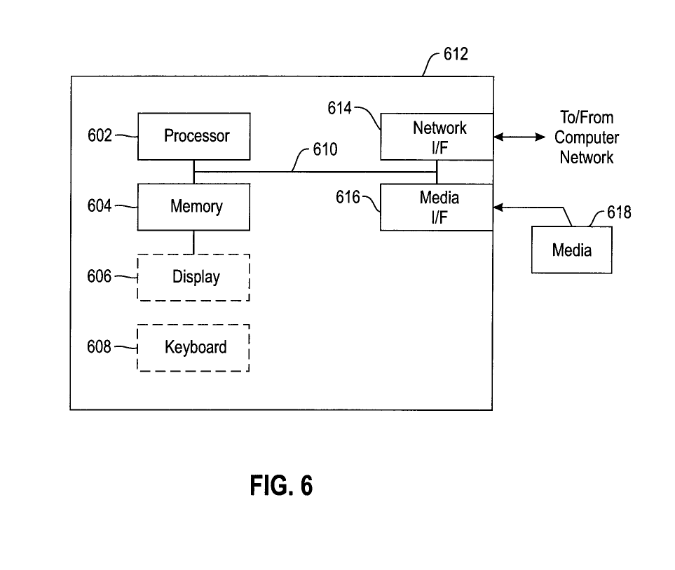

Additionally, an aspect of the present invention can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, radio frequency (RF), etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention. The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of to stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, leveraging the consolidation of data paths to improve I/O performance.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
implementing a shared image file on a host server;
consolidating multiple duplicate blocks across multiple virtual machines on the shared image file; and
creating a merged data path for the multiple virtual machines via the shared image file based on the multiple consolidated duplicate blocks;
wherein at least one of the steps is carried out by a computing device.

2. The method of claim 1, wherein said shared image file comprises a merged collection of multiple disk blocks across the multiple virtual machines.

3. The method of claim 1, wherein said consolidating comprises creating a lean disk image associated with the multiple virtual machines.

4. The method of claim 1, wherein said creating comprises leveraging one or more existing host page caches to improve performance.

5. The method of claim 1, comprising:
facilitating multiple guest virtual machines to transparently share the shared image file.

6. The method of claim 1, comprising:
redirecting input/output from a private disk image of each of the multiple virtual machines to the shared image file.

7. The method of claim 1, comprising:
incorporating a distributed deduplication across the multiple virtual machines using the shared image file.

8. The method of claim 1, wherein the shared image file is stored in a header of a private image file.

9. The method of claim 1, wherein each write operation performed by one of the multiple virtual machines is masked by an identifier corresponding to the one virtual machine.

10. The method of claim 1, wherein said shared image file comprises multiple fixed-size hash components.

11. The method of claim 10, wherein the number of said multiple fixed-size hash components is configurable.

12. An article of manufacture comprising a computer readable storage medium having computer readable instructions tangibly embodied thereon which, when implemented, cause a computer to carry out a plurality of method steps comprising:
implementing a shared image file on a host server;
transparently consolidating multiple duplicate blocks across multiple virtual machines on the shared image file; and
creating a merged data path for the multiple virtual machines via the shared image file based on the multiple consolidated duplicate blocks.

13. The article of manufacture of claim 12, wherein said shared image file comprises a merged collection of multiple disk blocks across the multiple virtual machines.

14. The article of manufacture of claim 12, wherein said consolidating comprises creating a lean disk image associated with the multiple virtual machines.

15. The article of manufacture of claim 12, wherein said creating further comprises leveraging one or more existing host page caches to improve performance.

16. The article of manufacture of claim 12, wherein the method steps comprise:
redirecting input/output from a private disk image of each of the multiple virtual machines to the shared image file.

17. A system comprising:
a memory; and
at least one processor coupled to the memory and configured for:
implementing a shared image file on a host server;
transparently consolidating multiple duplicate blocks across multiple virtual machines on the shared image file; and
creating a merged data path for the multiple virtual machines via the shared image file based on the multiple consolidated duplicate blocks.

18. A method comprising:
pre-allocating storage space on a shared image file on a host server, wherein said pre-allocating comprises pre-allocating one unit of storage space per each one of multiple virtual machines;
consolidating multiple duplicate blocks across the multiple virtual machines on the pre-allocated storage space on the shared image file; and
creating a merged data path for the multiple virtual machines via the shared image file based on the multiple consolidated duplicate blocks;
wherein at least one of the steps is carried out by a computing device.

19. The method of claim 18, comprising:
allocating an additional amount of storage space to one of the multiple virtual machines.

20. The method of claim 19, wherein said allocating comprises allocating an additional amount of storage space from a nearest available location in the shared image file.
